(19) United States
(12) Patent Application Publication
(10) Pub. No.: US 2016/0119663 A1
(43) Pub. Date: Apr. 28, 2016

(54) AUTHENTICATION DEVICE, AUTHENTICATION METHOD, AND AUTHENTICATION SYSTEM

(71) Applicant: Panasonic Intellectual Property Management Co., Ltd., Osaka (JP)

(72) Inventors: Kazuhiko Yamaguchi, Fukuoka (JP); Yasushi Yokomitsu, Fukuoka (JP)

(21) Appl. No.: 14/814,257

(22) Filed: Jul. 30, 2015

(30) Foreign Application Priority Data
Oct. 24, 2014 (JP) 2014-217575

(51) Int. Cl. H04N 21/258; H04N 21/231; H04N 21/2743; H04N 21/41; H04N 21/4223; H04N 21/414

(52) U.S. Cl. CPC H04N 21/25875; H04N 21/4223; H04N 21/41422; H04N 21/41407; H04N 21/2743; H04N 21/4135; H04N 21/23109

(57) ABSTRACT

An authentication device includes: a communication section that is able to communicate with an in-vehicle system or an imaging device which is wearable by a user; an authentication section that authenticates login of the user for operating the in-vehicle system; and a storage section that stores login information including identification information of the user whose login is authenticated, in which the communication section transmits the login information stored in the storage section to the imaging device for copy when the user logs in to the in-vehicle system, and does not transmit the login information to the imaging device when the user does not log in to the predetermined in-vehicle system.

### BACKGROUND OF THE INVENTION

1. Field of the Invention

The present invention relates to an authentication device that authenticates an imaging device (for example, a wearable camera), an authentication method, and an authentication system.

2. Description of the Related Art

In recent years, in order to support work of a police officer and a security guard, introduction of an imaging device (for example, a wearable camera) worn by the police officer and the security guard has been reviewed.

Here, as an authentication system using a terminal device which is a flashlight camera, for example, there is an authentication system disclosed in Japanese Patent Unexamined Publication No. 2014-146184.

The authentication system disclosed in Japanese Patent Unexamined Publication No. 2014-146184 includes a terminal device which is a flashlight camera, a cradle having a charging function of the terminal device, and a personal computer (PC) connected to the cradle. A security guard who starts a patrol performs authentication work including input of individual authentication information, and then, extracts the terminal device from the cradle. Video recording is started in response to the extraction in the terminal device, and a security start notification email including authentication result data is transmitted to an external device connected to the PC from the PC. If the security guard finishes the patrol and then returns the terminal device to the cradle, a security end notification email is transmitted to the external device from the PC. Then, the video recording in the terminal device is terminated, and then, captured image data is transmitted to a main recording medium in the PC.

However, in the configuration disclosed in Japanese Patent Unexamined Publication No. 2014-146184, when the security guard (user) is authenticated in the PC but plural terminal devices having an imaging function are provided, it is difficult to know which terminal device is carried by the user, and thus, it is difficult to recognize which user captures a video image recorded by the terminal device.

### SUMMARY OF THE INVENTION

In order to solve the above problems, an object of the invention is to provide an authentication device, an authentication method, and an authentication system capable of clearly indicating the relationship between a captured video image and a user who captures the video image, and clearly indicating who the user who captures the video image is to a third party.

According to an aspect of the invention, there is provided an authentication device including: a communication section that is able to communicate with an in-vehicle system or an imaging device which is wearable by a user; an authentication section that authenticates login of the user for operating the in-vehicle system; and a storage section that stores login information including identification information of the user whose login is authenticated by the authentication section, in which the communication section transmits the login information stored in the storage section to the imaging device for copy when the user logs in to the in-vehicle system, and does not transmit the login information to the imaging device when the user does not log in to the in-vehicle system.

According to another aspect of the invention, there is provided an authentication method in an authentication device, including: authenticating login of a user for operating an in-vehicle system; storing login information including identification information of the user whose login is authenticated in a storage section; transmitting, when the user logs in to the in-vehicle system, the login information stored in the storage section to an imaging device which is wearable by the user; and non-transmitting, when the user does not log in to the in-vehicle system, the login information to the imaging device.

According to still another aspect of the invention, there is provided an authentication system including: an imaging device which is wearable by a user; and an authentication device connected to an in-vehicle system, in which the authentication device includes a first communication section that communicates with the in-vehicle system or the imaging device, an authenticating section that authenticates login of the user for operating the in-vehicle system of the user, and a storage section that stores login information including identification information of the user whose login is authenticated by the authenticating section, in which the first communication section transmits the login information stored in the storage section to the imaging device for copy when the user logs in to the in-vehicle system, and does not transmit the login information to the imaging device when the user does not log in to the in-vehicle system, and in which the imaging device includes a second communication section that receives the login information transmitted from the first communication section, and an imaging section that captures a video image after the login information is received by the second communication section.

According to the invention, it is possible to clearly indicate the relationship between a captured video image and a user who captures the video image, and to clearly indicate who the user who captures the video image is to a third party.

### BRIEF DESCRIPTION OF DRAWINGS

FIG. 1 is a diagram illustrating an outline of a conventional in-vehicle camera system provided in a police patrol car and usage of video data captured by the in-vehicle camera system;

FIG. 2 is a block diagram illustrating an example of an internal configuration of a wearable camera of the exemplary embodiment;

FIG. 3 is a block diagram illustrating an example of an internal configuration of wearable camera of the exemplary embodiment;

FIG. 4A is a diagram illustrating an example of an appearance of a housing of the wearable camera of the exemplary embodiment;

FIG. 4B is a diagram illustrating another example of the appearance of the housing of the wearable camera of the exemplary embodiment;

FIG. 4C is a diagram illustrating an example of an appearance of a housing of an external adopter where the housing of the wearable camera of the exemplary embodiment is mounted;

FIG. 5 is a diagram illustrating an example of an operation outline after login processing of the authentication system of the exemplary embodiment;

FIG. 6 is a diagram illustrating an example of an operation outline after logout processing of the authentication system of the exemplary embodiment;

FIG. 7 is a diagram illustrating an example of login information;

FIG. 8 is a flowchart illustrating an example of an operation procedure of a PC of the exemplary embodiment; and

FIG. 9 is a diagram illustrating an example of an event list.

### DETAILED DESCRIPTION OF THE PREFERRED EMBODIMENT

Hereinafter, an embodiment (hereinafter, referred to as an “exemplary embodiment”) that specifically discloses an authentication device, an authentication method, and an authentication system according to the invention will be described in detail with reference to the accompanying drawings. In the exemplary embodiment, as an example of the authentication device according to the invention, a lap-top PC (personal computer) capable of being easily carried is described, but the authentication device is not limited to the lap-top PC, and for example, a wireless communication device that includes an input section and an authentication section and is capable of performing authentication, such as a smartphone, a portable phone, a tablet terminal or a personal digital assistant (PDA) may be used.

The PC which is an example of the authentication device of the exemplary embodiment communicates with a predetermined in-vehicle system (for example, an in-vehicle camera system, which is the same hereinafter) or a wearable camera which is wearable by a user (for example, a police officer, which is the same hereinafter), and authenticates login of the user to the predetermined in-vehicle system. Further, the PC stores login information including identification information of the user whose login is authenticated. Further, when the user logs in to the predetermined in-vehicle system, the PC transmits the stored login information to the wearable camera for copy, and when the user does not log in to the predetermined in-vehicle system, the PC does not transmit the login information to the wearable camera.

Here, it is assumed that authentication system 100 of the exemplary embodiment is used in a police station, but authentication system 100 may be used in various offices (for example, a security company) without limiting a police officer as a user.

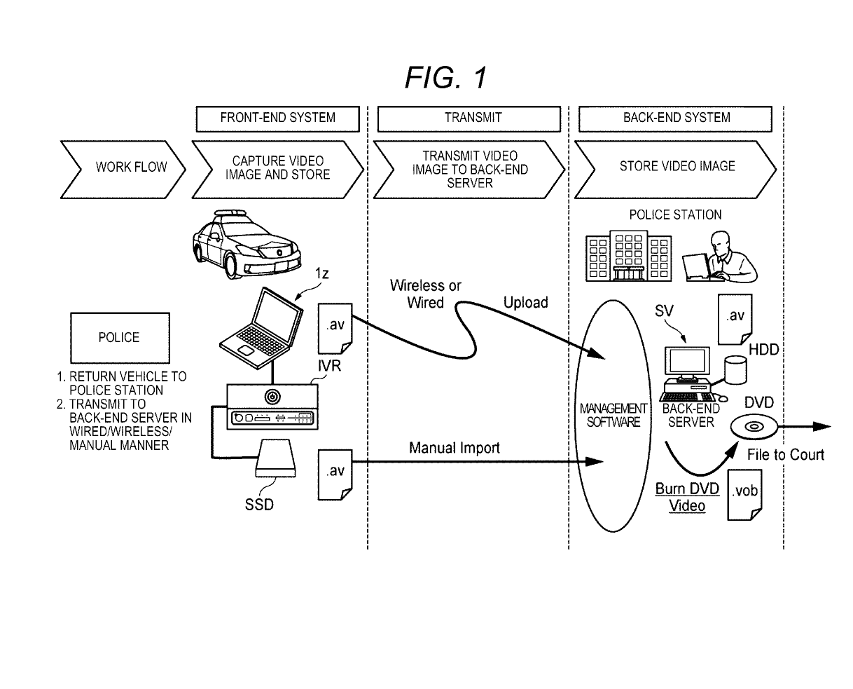

FIG. 1 is a diagram illustrating an outline of a conventional in-vehicle camera system provided in a police patrol car, and usage of video data captured by in-vehicle camera system IC. The in-vehicle camera system shown in FIG. 1 is provided in the patrol car, and includes in-vehicle video recorder IVR, a video camera (not shown), and external storage SSD (for example, a hard disk drive or a solid state drive). The in-vehicle camera system generates a data file of a video image including images captured by the video camera, and accumulatively stores the data file in in-vehicle video recorder IVR (or external storage SSD, as necessary).

In FIG. 1, when a police officer is dispatched from a police station for a predetermined work (for example, patrol), the police officer carries PC 1z from the inside of the police station, and connects PC 1z to the in-vehicle camera system provided in the patrol car for communication. PC 1z stores a data file of a video image captured during patrolling in in-vehicle video recorder IVR according to an operation of the police officer. When the patrol is finished and the patrol car returns to the police station, PC 1z transmits the data file of the video image stored in in-vehicle video recorder IVR (or external storage SSD, as necessary) to back-end server SV (for example, a predetermined server device provided in the police station).

A front-end system shown in FIG. 1 includes a patrol car in which a police officer who is dispatched to a front line at a site rides, and an in-vehicle camera system provided in the patrol car, and for example, captures a video image at the site where the patrol car arrives by a video camera (not shown), and accumulatively stores a data file of the captured video image in in-vehicle video recorder IVR (or external storage SSD, as necessary).

The back-end system shown in FIG. 1 includes back-end server SV provided in the police station, management software for performing communication with the front-end system, and an external hard disk (HDD) connected to the back-end server SV as storage, and for example, accumulates the data file of the video image transmitted from the front-end system. The data file of the video image stored in the back-end system is used by a person in charge in a relevant department in the police station. Further, as necessary, the data of the video image is copied onto a predetermined storage medium (for example, a digital versatile disk (DVD)) to be submitted as an evidence in a predetermined scene (for example, a trial).

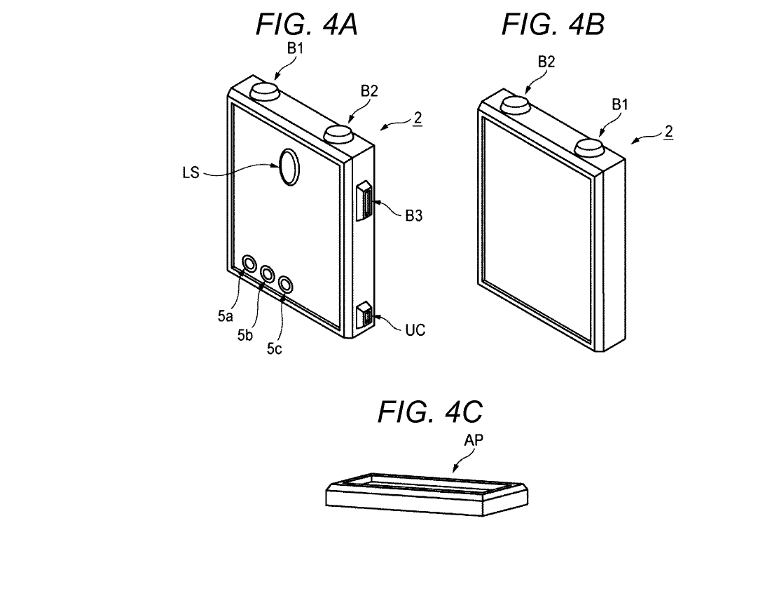

In the exemplary embodiment, it is assumed that wearable camera 2 (see FIGS. 4A and 4B) which is an example of an imaging device which is wearable by a police officer is further provided, for example, in order to precisely obtain and store a video image which is an evidence of the site with respect to front-end system (namely, the in-vehicle camera system) shown in FIG. 1. Here, since an input terminal is not provided in wearable camera 2, if the relationship between a specific police officer and a carried specific wearable camera 2 is not properly managed, for example, when a video image is submitted as evidence data in a trial, it is difficult to specify a police officer who captures the video image displayed on a monitor (not shown) in a court, and thus, reliability of the evidence is lowered.

Thus, in the exemplary embodiment to be described below, PC 1 which is an example of an authentication device that reliably guarantees the relationship between a video image captured in the front-end system and a police officer who captures the video image and clearly shows who the police officer who captures the video image is to a third party will be described.

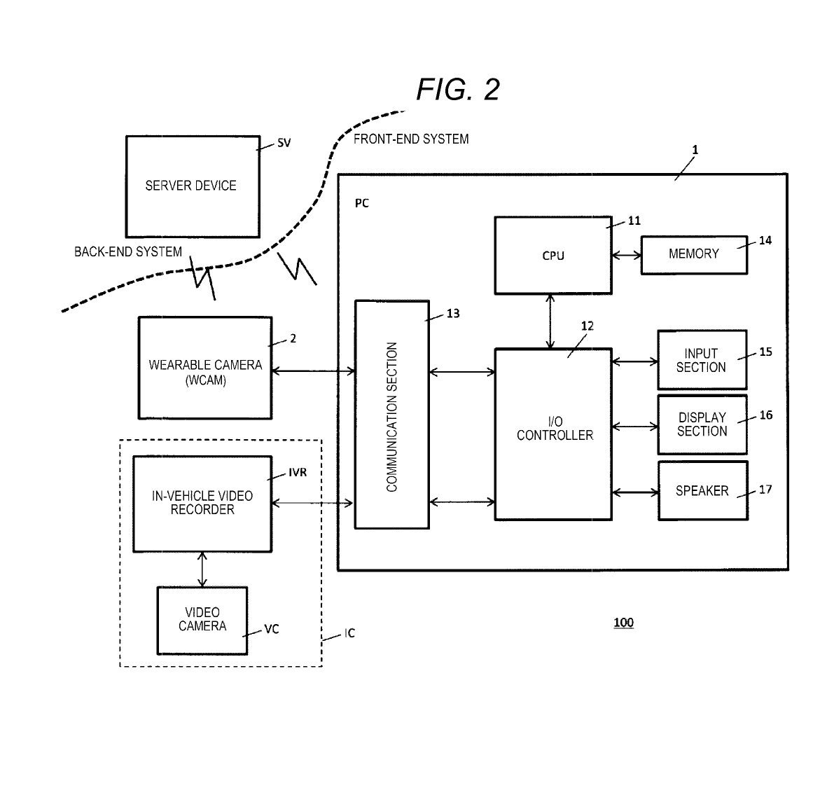

FIG. 2 is a block diagram illustrating an example of a system configuration of authentication system 100 of the exemplary embodiment. Authentication system 100 shown in FIG. 2 includes personal computer (PC) 1, wearable camera 2 (WCAM), in-vehicle recorder IVR, video camera VC, and server device SV. PC 1, wearable camera 2, in-vehicle recorder IVR, and video camera VC are provided in the front-end system shown in FIG. 1, and server device SV is provided in the back-end system shown in FIG. 1.

PC 1 which is an example of the authentication device includes CPU 11, I/O controller 12, a communication section 13, memory 14, input section 15, display section 16, and speaker 17. PC 1 is able to communicate with wearable camera 2 and in-vehicle recorder IVR of the front-end system, respectively, and is able to communicate with server device SV of the back-end system.

CPU 11 performs control processing for generally controlling operations of the respective sections of PC 1, input/output processing of data between CPU 11 and the other respective sections through I/O controller 12, data operation (calculation) processing, and data storage processing. For example, CPU 11 which is an example of the authentication section performs authentication about whether to permit login of a user to in-vehicle camera system IC based on an input operation of the user with respect to a login screen (not shown) to in-vehicle camera system IC displayed in display section 16 (that is, performs user authentication). The input operation of the user is an operation of inputting an ID (user identification information), a password, and the like, for example. A variety of information relating to the user who is a login permission target is stored in memory 14 in advance, for example, and CPU 11 performs authentication (determination) about whether to permit login of the user to in-vehicle camera system IC using information on the login permission target stored in memory 14 in advance. The login may be login to in-vehicle camera system IC through PC 1, or may be login to an application that operates in-vehicle camera system IC mounted in PC 1.

I/O controller 12 performs control relating to input/output of data between CPU 11 and the respective sections (specifically, communication section 13, input section 15, display section 16, and speaker 17) of PC 1, and performs relay of data from CPU 11 and data to CPU 11. I/O controller 12 may be integrally formed with CPU 11.

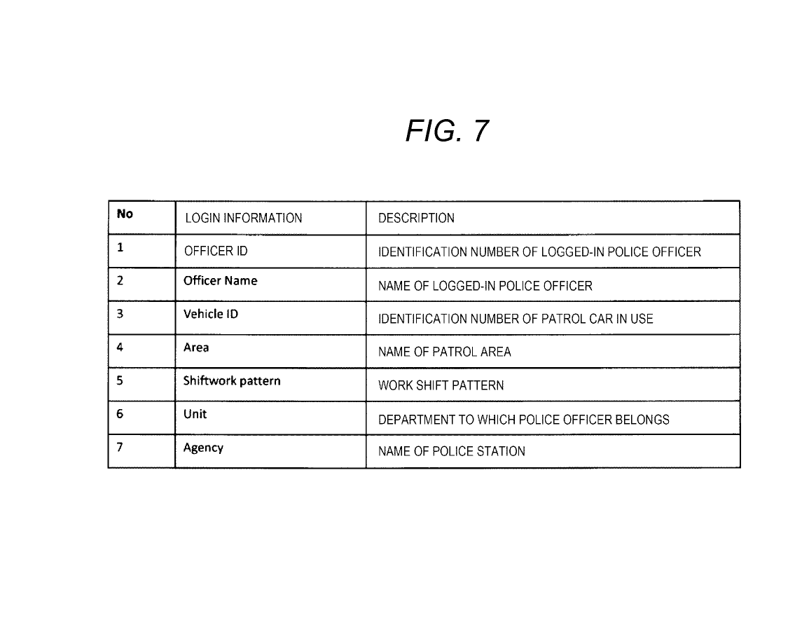

Communication section 13 performs communication with in-vehicle camera system IC provided in the patrol car, or with wearable camera 2 which is wearable by the user, in a wired or wireless manner. When user logs in to in-vehicle camera system IC, communication section 13 transmits login information (see FIG. 7) stored in memory 14 to wearable camera 2 for copy, and on the other hand, when the user does not log in to in-vehicle camera system IC, communication section 13 does not transmit the login information to wearable camera 2.

Memory 14 which is an example of the storage section is configured using a random access memory (RAM), a read only memory (ROM), and a non-volatile or volatile semiconductor memory, for example. Memory 14 functions as a work memory when CPU 11 is operated, and stores a predetermined program for operating CPU 11, and data. Further, memory 14 stores a variety of information (for example, “Officer ID”) relating to the user whose login to in-vehicle camera system IC is permitted, and stores login information (see FIG. 7) including identification information on the user whose login to in-vehicle camera system IC is permitted (authenticated) by CPU 11.

FIG. 7 is a diagram illustrating an example of login information. The login information shown in FIG. 7 includes actual data corresponding to respective items of “Officer ID”, “Officer Name”, “Vehicle ID”, “Area”, “Shiftwork pattern”, “Unit”, and “Agency”. The “Officer ID” represents identification information of the user whose login is permitted (namely, a logged-in police officer). The “Officer Name” represents a name of the logged-in police officer. The “Vehicle ID” represents an identification number of a patrol car which is being used. The “Area” represents a name of an area that the police officer patrols. The “Shiftwork pattern” represents a pattern of Shiftwork of the police officer.

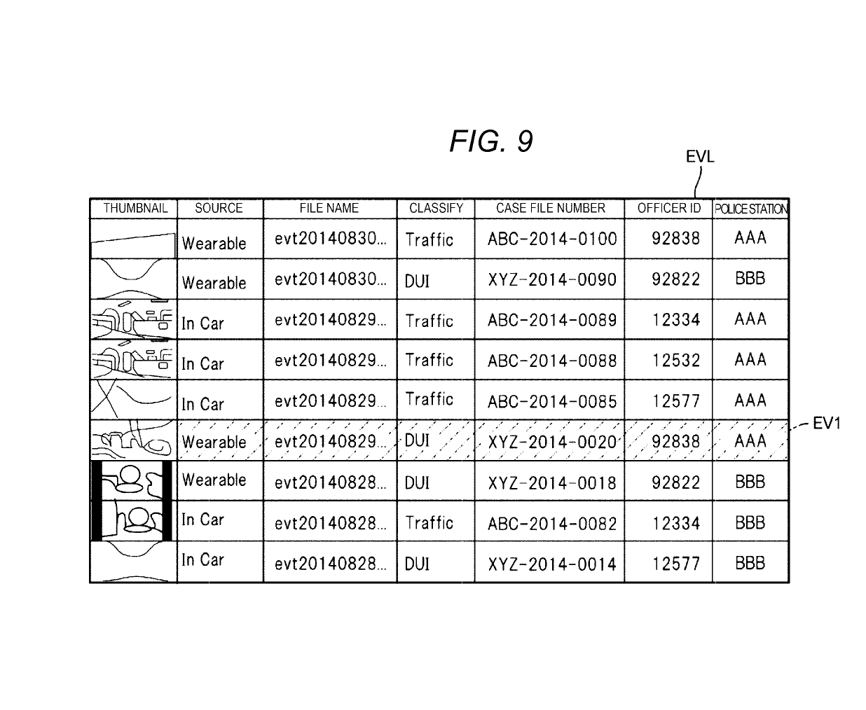

The “Unit” represents a department to which the police officer belongs. The “Agency” represents a name of a police station where the police officer works. As the login information includes “Officer Name”, “Vehicle ID”, “Area”, “Shiftwork pattern”, “Unit”, and “Agency”, in addition to “Officer ID”, for example, in the back-end system, the user can use each item as a search key, to thereby easily retrieve desired event list EVL (see FIG. 9).

Input section 15 is a user interface (UI) for receiving an input operation of the user and notifying the CPU 11 of the input through I/O controller 12, and for example, is a pointing device such as a mouse or a keyboard. Further, input section 15 is disposed corresponding to a screen of display section 16, for example, and may be configured using a touch panel or a touch pad capable of being operated by a finger of a user or a stylus pen.

Display section 16 is configured using a liquid crystal display (LCD) or an organic electroluminescence (EL) display, for example, and displays a login screen (not shown) to in-vehicle camera system IC on a screen thereof according to an input operation of the user, for example. Further, when video data image-captured (recorded) by wearable camera 2 is input according to an input operation of the user, for example, display section 16 displays a video image included in the video data on the screen under an instruction of CPU 11.

When video data including sound image-captured (recorded) by wearable camera 2 is input according to an input operation of the user, for example, speaker 17 outputs the sound included in the video data under an instruction of CPU 11. Display section 16 and speaker 17 may be configured separately from PC 1.

In-vehicle video recorder IVR is connected between PC 1 and video camera VC to be able to perform communication, and transmits data file of a video image captured by video camera VC to PC 1 according to an input operation of the user whose login to in-vehicle camera system IC is permitted (authenticated), or accumulatively stores the data file in in-vehicle video recorder IVR. In authentication system 100 of the exemplary embodiment, in-vehicle camera system IC which is an example of a predetermined in-vehicle system is configured by in-vehicle video recorder IVR and video camera VC.

Video camera VC is configured by a front camera (not shown) for imaging a front side of the patrol car, and a back camera (not shown) for imaging a back seat (namely, a seat where a suspect is seated) in the patrol car, for example, and accumulatively stores a data file of a video image obtained by capturing in in-vehicle video recorder IVR. A microphone (not shown) that records sound of the outside of vehicle may be provided to the front camera. A microphone may also be provided to the back camera. Thus, sound generated by the police officer or the suspect in the patrol car can be recorded.

Server device SV receives a data file (which will be described later) of a video image transmitted from PC 1 or wearable camera 2, and stores the data file in a storage (not shown) in server device SV. Server device SV generates and stores an event list including an identification number of wearable camera 2 and an identification number (namely, “Officer ID”) of a user of login information included in the data file of the video image using the data file of the video image transmitted from PC 1 or wearable camera 2 (see FIG. 9).

FIG. 9 is a diagram illustrating an example of event list EVL. Event list EVL shown in FIG. 9 includes actual data corresponding to respective items of “video thumbnail”, “source (origin: wearable camera 2 or video camera VC in the exemplary embodiment)”, “file name”, “group”, “case number”, “officer ID”, and “police station”, for example. Event list EVL is displayed in server device SV or a display device (not shown) connected to server device SV according to an input operation of the user (for example, a person in charge in a department different from that of the police officer who is dispatched at the site (for example, a detective who draws up a protocol)) of server device SV, for example.

According to event list EVL shown in FIG. 9, the user generates a video data file so that wearable camera 2 includes identification information on wearable camera 2 in the file name, or generates the video data and meta data including the identification information on wearable camera 2 as separate files, so that the user can confirm the relationship between each video image captured by wearable camera 2 and the police officer who captures the video image, and can clearly recognize which police officer captures the video image captured using wearable camera 2 at the site. If there is an event to be watched in event list EVL, the user may designate the event using the mouse or the like for selection. In FIG. 9, portion EV1 indicated by double dot chain lines represents a selected event.

Contents corresponding to respective items of login information (see FIG. 7) are included in respective items of event list EVL shown in FIG. 9, but a part of the items of the login information is not shown in FIG. 9. Thus, although not shown in FIG. 9, it is preferable that items indicating identification information on wearable camera 2 which is actually used are included in the items of event list EVL.

Further, when transmitting (uploading) data on partial items among the respective items of event list EVL shown in FIG. 9 to server device SV from wearable camera 2, if data on items received by server device SV (data on items directly input by wearable camera 2) is present, the data is also transmitted (uploaded) to server device SV. Here, data on items input through PC 1 is also present. In order to prevent falsification of the transmitted data file, server device SV of the back-end system displays the data on the items input through PC 1 in a display device so that the display of the data can be identified to be different from the data on the items which are not input through PC 1. Thus, the user can distinctly identity the data on the items input later through PC 1 from the data on the items directly input (given) by wearable camera 2, and reliably guarantee the relationship between the captured video image and the user who captures the video image.

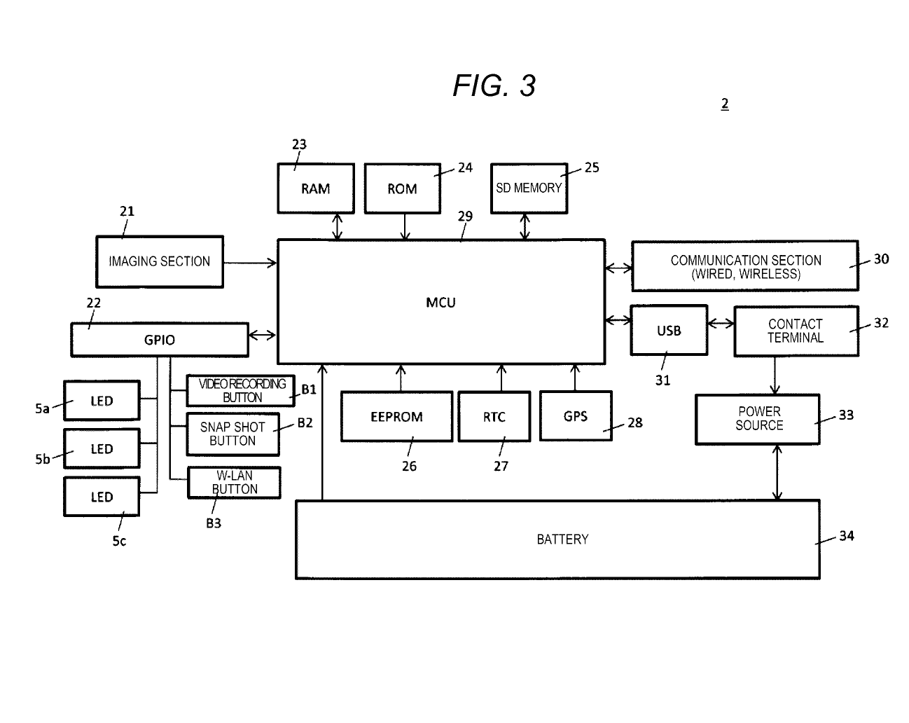

FIG. 3 is a block diagram illustrating an example of an internal configuration of wearable camera 2 of the exemplary embodiment. FIG. 4A is a diagram illustrating an example of an appearance of a housing of wearable camera 2 of the exemplary embodiment. FIG. 4B is a diagram illustrating another example of the appearance of the housing of wearable camera 2 of the exemplary embodiment. In the appearance of wearable camera 2 shown in FIG. 4B, a state where the appearance of wearable camera 2 shown in FIG. 4A is horizontally rotated by an angle of 180° is shown.

Wearable camera 2 shown in FIG. 3 includes imaging section 21, general purpose input/output (GPIO) 22, RAM 23, ROM 24, SD memory 25, electrically erasable programmable read-only memory (EEPROM) 26, real time clock (RTC) 27, global positioning system (GPS) 28, MCU 29, communication section 30, universal serial bus (USB) 31, contact terminal 32, power source 33, battery 34, video recording button B1, snap shot button B2, W-LAN button B3, and three types of light emitting diodes (LED) 5a, 5b, and 5c.

As shown in FIGS. 4A and 4B, wearable camera 2 is formed in a vertically elongated rectangular shape, in which lens LS is provided in the middle of an upper part (see FIG. 4A) on a front surface of a main body thereof, and video recording button B1 and snap shot button B2 are provided on an upper surface of the main body of wearable camera 2. Further, three types of LEDs 5a to 5c are provided at equal intervals in a lower part of the front surface of the main body of wearable camera 2, and W-LAN button B3 (for example, a button capable of controlling Wi-Fi (registered trademark)) and USB connector UC are provided on a right surface of the main body of wearable camera 2.

Contact terminal 32 for being electrically connected to a cradle (not shown) or external adaptor AP is provided on a lower surface of the main body of wearable camera 2. Video recording button B1 is a button operated when video capturing is started or terminated. As video recording button B1 is pressed odd-number of times, imaging of a moving picture (video image) is started, and as video recording button B1 is pressed even-number of times, imaging of a motion (video image) is terminated. Snap shot button B2 is a button operated when imaging of a still picture is performed.

LED 5a represents a power-on state of wearable camera 2, and is turned on when a power button (not shown) is pressed. LED 5b represents a video recording state of wearable camera 2, and is turned on when video recording button B1 is pressed odd-number of times, and is turned off when video recording button B1 is pressed even-number of times. LED 5b is continuously turned on during video recording. LED 5c represents a wireless communication state based on W-LAN, and is turned on when W-LAN button B3 is pressed. LED 5c is an LED capable of two-color lighting, and is turned on with different colors by pressing W-LAN button B3. That is, LED 5c is turned on with a first color (for example, red) by first pressing, is turned on with a second color (for example, green) by second pressing, and is turned off by third pressing. These states are repeated by pressing W-LAN button B3. Namely, LED 5c repeats the first color turning-on, the second color turning-on, the turning off, the first color turning-on, and so on whenever W-LAN button B3 is pressed.

An access point mode and a station mode are prepared in wearable camera 2 as modes relating to communication. The modes are switched in the order of the access point mode, the station mode, a communication-off mode, the access point mode, and so on whenever W-LAN button B3 is pressed. Further, the lighting color of LED 5c is changed according to the mode switching. That is, LED 5c is turned on with the first color (for example, red) in the access point mode, and is turned on with the second color (for example, green) in the station mode. LED 5c is turned off in the communication-off mode.

The station mode is a mode operated when wearable camera 2 requests establishment of communication connection using an external device (not shown) as an access point in Wi-Fi (registered trademark) communication, for example. The access point mode is a mode in which wearable mode 2 is operated as an access point when an external device (not shown) requests establishment of communication connection using wearable camera 2 as the access point in Wi-Fi (registered trademark) communication, for example.

“Charging terminal V+”, “CON.DET terminal”, “data terminals D− and D+”, and “ground terminal” which are all not shown are provided in contact terminal 32. The CON.DET terminal is a terminal for detection of a voltage change. The data terminals D− and D+ are terminals for transmission of a data file of a video image captured by wearable camera 2 to PC 1 through USB connector terminal UC, for example. Contact terminal 32 is connected to MCU 29 through USB 31, and is connected to a connector (not shown) of the cradle (not shown) or external adapter AP. That is, as wearable camera 2 is set to the cradle (not shown) or external adopter AP, contact terminal 32 is connected to a connector of the cradle (not shown) or external adaptor AP. As contact terminal 32 is connected to the connector of the cradle (not shown) or external adaptor AP, data communication is available between wearable camera 2 and PC 1.

Imaging section 21 has a solid state imaging device such as a charge coupled device (CCD) type image sensor or a complementary metal oxide semiconductor (CMOS) type image sensor, in addition to the above-described lens LS, and outputs video data obtained by imaging to MCU 29. GPIO 22 is a parallel interface, and performs signal input and output between the above-described video recording button B1, snap shot button B2, W-LAN button B3, LEDs 5a to 5c, and MCU 29.

RAM 23 is a work memory used in an operation of MCU 29. ROM 24 stores a program for controlling MCU 29, and data in advance. SD memory 25 stores video data captured by imaging section 21. SD memory 25 may be attached to or detached from the main body of the housing of wearable camera 2.

EEPROM 26 stores a serial number for identification of wearable camera 2. RTC 27 counts current time information, and outputs the current time information to MCU 29. GPS 28 receives current position information of wearable camera 2 through a GPS receiver (not shown), and outputs the position information to MCU 29.

MCU 29 performs control processing for generally controlling operations of the respective sections of wearable camera 2, data input/output processing with respect to other sections, data operation (calculation) processing, and data storage processing, and is operated according to the program and data stored in ROM 24. In the operation, MCU 29 uses RAM 23, and obtains the current time information from RTC 27 and the current position information from GPS 28.

Further, MCU 29 detects pressing of each button of video recording button B1, snap shot button B2, and W-LAN button B3, and performs processing for the pressed button. That is, when video recording button B1 is pressed, MCU 29 stores the video data output from imaging section 21 in SD memory 25 as a moving picture. Further, when snap shot button B2 is pressed, MCU 29 stores video data captured when snap shot button B2 is pressed in SD memory 25 as a still picture.

Further, when video recording button B1 is pressed odd-number of times, MCU 29 turns on LED 5a. When video recording button B1 is pressed even-number of times, MCU 29 turns off LED 5a. When W-LAN button B3 is pressed, MCU 29 performs wireless communication using W-LAN in communication section 30. When W-LAN button B3 is pressed, MCU 29 turns on LED 5c. Here, when the mode relating to communication is the access point mode, MCU 29 turns on LED 5c with the first color, and when the mode is the station mode, MCU 29 turns on LED 5c with the second color.

MCU 29 performs processing relating to authentication of a user of wearable camera 2 between wearable camera 2 and personal computer PC 1, in addition to the imaging of the moving picture, the imaging of the still picture, and the W-LAN wireless communication. The processing relating to the authentication is performed by PC 1. Authentication system 100 according to the exemplary embodiment performs association between an officer ID (“Officer ID”) given to a police officer in advance and a data file of a video image captured by wearable camera 2 carried by the police officer in PC 1, to thereby easily recognize which user (for example, police officer) makes the data file of the captured video image.

Communication section 30 regulates connection between communication section 30 and MCU 29 on a physical layer which is a first layer of an open system interconnection (OSI) reference model, and performs W-LAN wireless communication (for example, Wi-Fi (registered trademark)) according to the regulation. USB 31 is a serial bus, and enables connection to PC 1 of wearable camera 2. Power source 33 charges battery 34 with power supplied from the cradle (not shown) or external adaptor AP through contact terminal 32. Battery 34 supplies power to the respective sections of wearable camera 2.

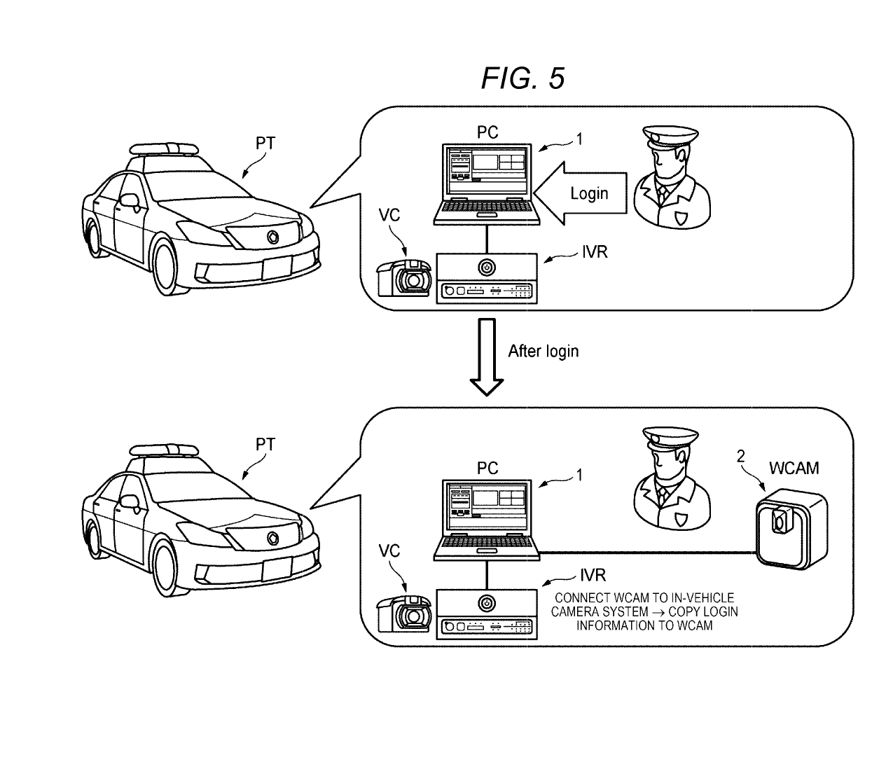

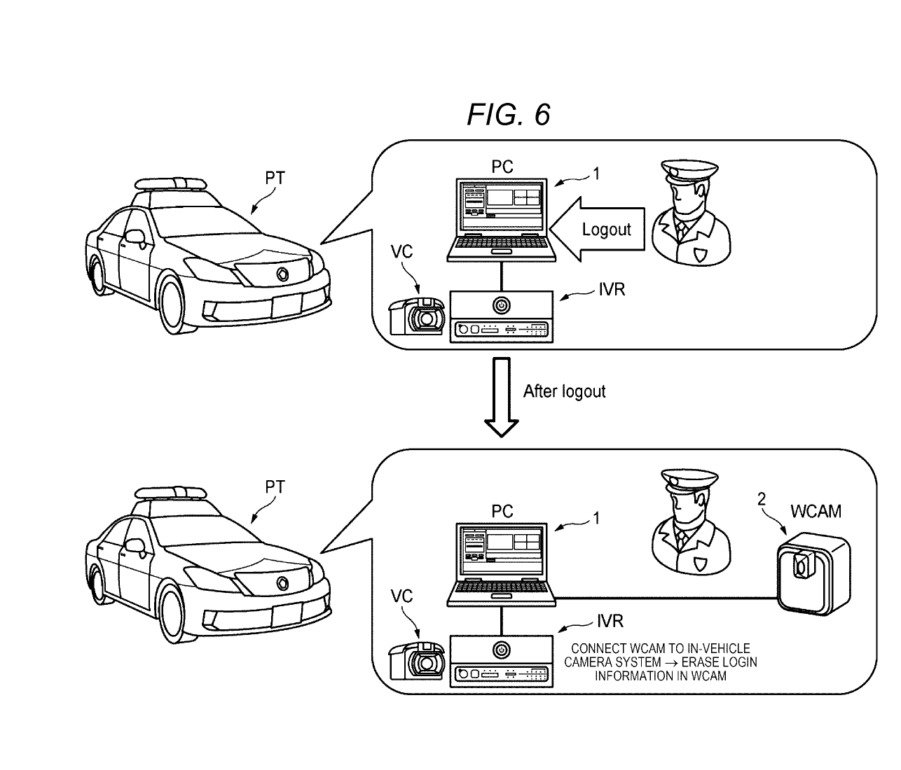

FIG. 5 is a diagram illustrating an example of an operation outline after login processing of authentication system 100 of the exemplary embodiment. FIG. 6 is a diagram illustrating an example of an operation outline after logout processing of authentication system 100 of the exemplary embodiment.

In FIG. 5, a police officer who is a user performs an input operation for login to in-vehicle camera system IC (namely, including in-vehicle video recorder IVR and video camera VC) provided in patrol car PT through PC 1, and if the login is permitted, PC 1 generates login information (see FIG. 7) including identification information of the police officer whose login is permitted (authenticated), and transmits the login information to wearable camera 2 (WCAM) for copy.

Further, even though the police officer who is the user is not logging in to in-vehicle camera system IC in a state where wearable camera 2 is connected to PC 1, when the login is performed in a state where wearable camera 2 is connected to PC 1, PC 1 may generate login information (see FIG. 7) including identification information of the police officer whose login is permitted (authenticated), and may transmit the login information to wearable camera 2 (WCAM) for copy.

In FIG. 6, if the police officer who is the user whose login is permitted (authenticated) performs an input operation for logout to in-vehicle camera system IC (namely, including in-vehicle video recorder IVR and video camera VC) provided in patrol car PT, PC 1 erases the login information including the identification information of the police officer whose login is permitted (authenticated) from wearable camera 2 (WCAM).

Further, when wearable camera 2 is not connected to PC 1 when the police officer who is the user performs the input operation for logout, wearable camera 2 erases the login information transmitted from PC 1 during login when the data file of the video image obtained by imaging is completely transmitted (uploaded) to server device SV. Thus, even when PC 1 cannot directly erase login information in a state where wearable camera 2 is not connected to PC 1, wearable camera 2 can erase unnecessary login information at a time point when it is considered that the use of wearable camera 2 is not necessary (for example, at a time point when the uploading of the data file of the video image is completed).

In authentication system 100 of the exemplary embodiment, the transmission (uploading) of the data file of the video image captured by wearable camera 2 to server device SV may be directly performed from wearable camera 2 after the connection between wearable camera 2 and PC 1 is released, or may be performed by PC 1 to which the data file is transmitted from wearable camera 2.

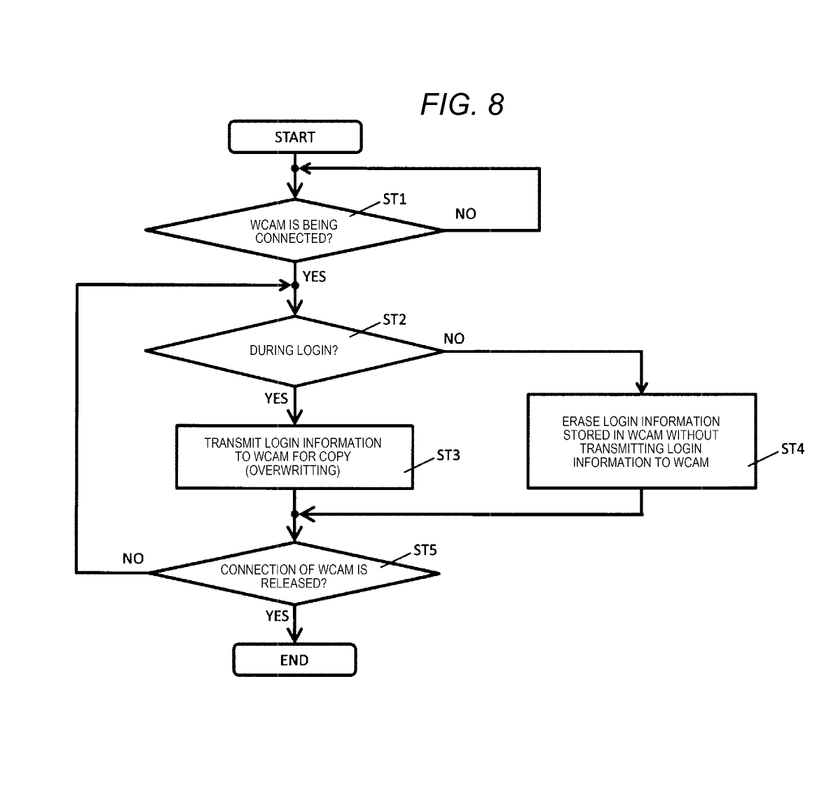

Next, an operation procedure of PC 1 of authentication system 100 of the exemplary embodiment will be described with reference to FIG. 8. FIG. 8 is a flowchart illustrating an example of an operation procedure of PC 1 of the exemplary embodiment. Respective processes of the flowchart shown in FIG. 8 are performed when a police officer who is a user carries wearable camera 2 for the purpose of patrol and rides in patrol car PT for dispatch, for example.

In FIG. 8, PC 1 waits until PC 1 is connected to wearable camera 2 (ST1, NO). A state where PC 1 is connected to wearable camera 2 corresponds to a case where PC 1 is connected to wearable camera 2 through a wired cable, or a case where a session is established to execute wireless communication between PC 1 and wearable camera 2, and a state where the police officer who is the user rides in patrol car PT. When wearable camera 2 is connected to PC 1 (ST1, YES), CPU 11 determines whether the police officer who is the user logs in to in-vehicle camera system IC provided in patrol car PT (ST2).

When it is determined that the police officer who is the user logs in to in-vehicle camera system IC provided in patrol car PT (ST2, YES), CPU 11 transmits login information (see FIG. 7) including identification information (that is, “Officer ID”) on the police officer who is the user to wearable camera 2 through I/O controller 12 and communication section 13 for copy (ST3). In this case, wearable camera 2 receives the login information transmitted from PC 1, and copies (overwrites) the login information into RAM 23 or SD memory 25.

In step ST3, CPU 11 does not perform a process of transmitting the same login information as the login information to be once transmitted to wearable camera 2 for copy to wearable camera 2 again for copy. In other words, when the connection between PC 1 and wearable camera 2 continues and the login to in-vehicle camera system IC of the police officer who is the user continues, since the same login information is overwritten, CPU 11 may not perform the process of step ST3.

On the other hand, when it is determined that the police officer who is the user does not currently log in to in-vehicle camera system IC provided in patrol car PT (in other words, logs out) (ST2, NO), CPU 11 does not transmit the login information to wearable camera 2, and when previous login information is stored in wearable camera 2, the CPU 11 erases the login information (ST4).

After step ST3 or step ST4, CPU 11 determines whether the connection between PC 1 and wearable camera 2 is released (ST5). When it is determined that the connection between PC 1 and wearable camera 2 is released (ST5, YES), the operation of PC 1 is terminated. On the other hand, when it is determined that the connection between PC 1 and wearable camera 2 is not released (ST5, NO), the operation of PC 1 returns to step ST2.

When it is determined in step ST5 that the connection between PC 1 and wearable camera 2 is released, wearable camera 2 starts video capturing at a predetermined timing. In other words, wearable camera 2 does not start the video capturing while wearable camera 2 is being connected to PC 1 (for example, while the police officer is riding in patrol car PT), and starts the video capturing after the connection to PC 1 is released (after the police officer arrives at the site and releases the connection to PC 1).

Here, the predetermined timing for starting the video capturing corresponds to any one of a time point when the connection to PC 1 is released from a state where wearable camera 2 is connected to PC 1 by a charging cable (not shown), a time point when video recording button B1 is pressed by the police officer, a time point when a door of a driver seat of patrol car PT that moves out once for dispatch is opened, or a time point when patrol car PT that moves out once for dispatch is stopped so that an engine is turned off. Wearable camera 2 terminates the video capturing when the police officer presses video recording button B1 again, for example.

Wearable camera 2 gives login information to a header area of data on a video image obtained by the video capturing to generate a data file of the video image, or associates the data file of the video image obtained by the video capturing with a metafile including the login information (see FIG. 7) which is meta data relating to the video image to generate a data file of the video image. Further, the generation of the data file is simultaneously performed with the video capturing, or is performed immediately after termination of the video capturing. After generating the data file of the video image, wearable camera 2 transmits (uploads) the data file of the video image to server device SV by a predetermined input operation of the police officer who is the user.

Here, the generation timing of the data file will be described in detail. If the data file can be generated all the time, for example, there is a possibility that the data file is prepared after the login information of the user is changed, and thus, there is a possibility that it is difficult to know who captures the video image. Thus, in the exemplary embodiment as described above, the generation of the data file is simultaneously performed with the video capturing or is performed immediately after termination of the video capturing, so that the data file is reliably associated with the user who captures the video image.

As described above, in authentication system 100 of the exemplary embodiment, since PC 1 which is an example of the authentication device of the exemplary embodiment authenticates login of a user (for example, police officer) to a predetermined in-vehicle system (for example, in-vehicle camera system IC provided in the patrol car), and stores login information including identification information (for example, “Officer ID”) on the user whose login is authenticated in memory 14. Further, when the user logs in to the predetermined in-vehicle system (for example, in-vehicle camera system IC), PC 1 transmits the login information stored in memory 14 to wearable camera 2 which is wearable by the user for copy, and on the other hand, when the user does not log in to the predetermined in-vehicle system (for example, in-vehicle camera system IC), PC 1 does not transmit the login information to wearable camera 2.

Thus, in authentication system 100 of the exemplary embodiment, since PC 1 transmits the login information of the user who logs in to the in-vehicle system to wearable camera 2 for copy before the video capturing is started by wearable camera 2, it is possible to reliably guarantee the relationship between the video image captured in wearable camera 2 and the user who captures the video image. Further, PC 1 can clearly show who captures the video image to a third party.

In addition, in authentication system 100 of the exemplary embodiment, PC 1 erases login information stored in memory 14 according to logout of the user from a predetermined in-vehicle system (for example, in-vehicle camera system IC) or termination of transmission (uploading) of the video image data captured by wearable camera 2 to server device SV. Thus, since it is considered that the use of wearable camera 2 is not necessary due to the logout of the user from the in-vehicle system (for example, in-vehicle camera system IC) or the termination of the transmission of the video image data of wearable camera 2, PC 1 does not need login information of the user, to thereby make it possible to erase unnecessary login information in preparation for the next use of wearable camera 2.

Further, in authentication system 100 of the exemplary embodiment, when the login information of the user to the predetermined in-vehicle system (for example, in-vehicle camera system IC) is not stored in memory 14, PC 1 prohibits wearable camera 2 from video capturing, or prohibits transmission of the video image data captured by wearable camera 2 to wearable camera 2 to server device SV. Thus, PC 1 can avoid a state where it is not possible to determine which user (for example, police officer) captures the video image data captured by wearable camera 2, and can notify the user that it is necessary to associate the login information of the user with the video data before transmission to server device SV, before the start of the video capturing in wearable camera 2 or even after the video capturing.

Further, in authentication system 100 of the exemplary embodiment, wearable camera 2 receives the login information transmitted from PC 1, and then, starts the video capturing according to a predetermined input operation of the user. Thus, wearable camera 2 can clearly perform association between the video image data and a user who captures the video image data using the identification information (for example, “Officer ID”) of the user included in the login information transmitted from PC 1 before starting the video capturing.

In addition, in authentication system 100 of the exemplary embodiment, since wearable camera 2 gives the login information to the data file (for example, a header area) of the captured video image, it is possible to clearly perform association between the video image data and a user who captures the video image data by the data file of the single video image.

Furthermore, in authentication system 100 of the exemplary embodiment, since wearable camera 2 generates the data file of the captured video image and a metafile including the login information which is meta data relating to the video image to be associated with each other, it is possible to clearly perform association between the video image data and a user who captures the video image data by the associated data file.

Hereinbefore, various embodiments are described with reference to the accompanying drawings, but the invention is not limited to the examples. It will be obvious to those skilled in the art that various modifications or revisions can be made within the categories disclosed in claims, which should be construed to be included in the technical scope of the invention.

In the above-described embodiment, it is assumed that one police officer rides in patrol car PT, but it may be assumed that plural (for example, two) police officers ride thereon. In this case, two police officers log in to in-vehicle camera system IC in a state where wearable camera 2 to be used by each police officer is connected to PC 1. Namely, PC 1 stores login information on two police officers in memory 14, and needs to transmit the login information on each police officer to corresponding wearable camera 2 for copy.

For example, when two wearable cameras 2 are connected to PC 1 in a wired manner (for example, through a USB), CPU 11 of PC 1 preferentially transmits login information on a police officer in a driver seat (police officer who logs in to a main login screen) to previously connected wearable camera 2 for copy, and transmits login information on a police officer in a passenger seat (police officer who logs in to a sub login screen) to later connected wearable camera 2 for copy. Further, CPU 11 determines priorities of two wearable cameras 2 to be connected according to serial numbers of the cameras, user's operations or the like. Further, CPU 11 causes the login information on the police officer in the driver seat to be copied to wearable camera 2 having high priority, and causes the login information on the police officer in the passenger seat to be copied to wearable camera 2 with low priority. In addition, CPU 11 may cause the login information on two police officers to be copied to both of two wearable cameras 2, and may cause the users of wearable cameras 2 to select any login information.

When two wearable cameras 2 are connected to PC 1 in a wireless manner, the priority may be used as described above, or alternatively, the users may select the priority.

FIG. 4C is a diagram illustrating an example of an appearance of a housing of external adaptor AP where the housing of wearable camera 2 of the exemplary embodiment is mounted. External adaptor AP shown in FIG. 4C is provided therein with a chip capable of performing wireless communication (for example, Bluetooth (registered trademark)), and if the wireless communication with PC 1 is disconnected, wearable camera 2 provided in external adaptor AP automatically starts video recording (imaging). Since the Bluetooth (registered trademark) communication method has a short communication range of ten or so meters, for example, compared with the Wi-Fi (registered trademark) communication method, it is possible to automatically start video recording (imaging) immediately after the police officer leaves patrol car PT, and thus, it is possible to enhance convenience of wearable camera 2.

Further, external adaptor AP shown in FIG. 4C may be provided with a battery (not shown) capable of supplying power to the respective sections of wearable camera 2, or may be used as a protective case of wearable camera 2.

In addition, a chip capable of performing wireless communication (for example, Bluetooth (registered trademark)) may be built in a fixing tool (for example, a clip for fixation to a uniform of the police officer) of wearable camera 2, or may be built in wearable camera 2.

Furthermore, wearable camera 2 may preferentially transmit (upload) a data file of an important video image having a predetermined priority to server device SV in emergencies. Wearable camera 2 transmits (uploads) a data file of a video image corresponding to a specific case file number or classification, with reference to “Case File Number” or “Classify” relating to a data file of a video image input through PC 1 as the predetermined priority, for example. Further, when the priority is not given, wearable camera 2 sequentially transmits (uploads) data files to server device SV so that a video image which is captured early is preferentially transmitted.

1.-7. (canceled)

8. A login authentication device to an in-vehicle camera system which links an in-vehicle camera system and a wearable camera which is wearable by a user through login information of the user to the in-vehicle camera system, the device comprising:
a communication section that is able to communicate with the in-vehicle camera system or the wearable camera;
an authentication section that authenticates login to the in-vehicle camera system of the user; and
a storage section that stores the login information including identification information of the user when login is permitted by the authentication section,
wherein the communication section transmits the login information stored in the storage section to the wearable camera for copy when the user logs in to the in-vehicle camera system, and
wherein the login information is given as meta data of video image data captured by the wearable camera.

9. The login authentication device to an in-vehicle camera system of claim 8, wherein the authentication section erases the login information stored in the wearable camera according to logout from the in-vehicle camera system of the user or termination of transmission of video data captured by the wearable camera to an external device.

10. The login authentication device to an in-vehicle camera system of claim 8, further comprising:
a controller that prohibits, when the login information is not stored in the storage section, the wearable camera from performing imaging in the wearable camera or transmitting the video data captured by the wearable camera to an external device.

11. A login authentication method in a login authentication device to an in-vehicle camera system which links an in-vehicle camera system and a wearable camera which is wearable by a user through login information of the user to the in-vehicle camera sy stem,
wherein the login authentication device to an in-vehicle camera system includes a storage section,
wherein the device executes:
communicating with the in-vehicle camera system or the wearable camera;
authenticating login of the user to the in-vehicle camera system;
storing login information including identification information of the user whose login is permitted by the authentication in a storage section; and
transmitting the login information stored in the storage section to the wearable camera for copy when the user logs in to the in-vehicle camera system, and
wherein the login information is given as meta data of video image data captured by the wearable camera.
